(19) United States
(12) Patent Application Publication
(10) Pub. No.: US 2021/0175557 A1
(43) Pub. Date: Jun. 10, 2021

(54) BATTERY CELL ASSEMBLY FOR A MOTOR VEHICLE

(71) Applicant: MAHLE International GmbH, Stuttgart (DE)

(72) Inventors: Erik Person, Stuttgart (DE); Mario Wallisch, Aichtal (DE)

(21) Appl. No.: 17/113,040

(22) Filed: Dec. 5, 2020

(30) Foreign Application Priority Data
Dec. 6, 2019 (DE) 10 2019 219 098.7

(51) Int. Cl. H01M 10/613; B60L 58/26; H01M 10/625; H01M 10/647; H01M 10/6556; H01M 2/10; H01M 10/6567

(52) U.S. Cl. CPC H01M 10/613; B60L 58/26; H01M 10/625; H01M 2220/20; H01M 10/6556; H01M 2/1077; H01M 10/6567; H01M 10/647

(57) ABSTRACT

A battery cell assembly includes a stack of multiple battery cells stacked on top of one another along a stacking direction. In intermediate spaces between two battery cells that are adjacent in the stacking direction, a cooling structure of a flexible and heat-conductive material that can each be flowed through by a coolant is arranged, which for the heat transfer from the battery cells to the respective cooling structure lies against the battery cells. The battery cells, the intermediate spaces and the cooling structures are matched to one another in such a manner that upon volume enlargement of the battery cells the volume of the intermediate spaces and thus also of the cooling structures is reduced, such that through the volume decrease coolant present in the cooling structure is at least partially channeled out of the same.

### CROSS REFERENCE TO RELATED APPLICATIONS

This application claims priority to German patent application DE 10 2019 219 098 7, filed Dec. 6, 2019, the entire content of which is incorporated herein by reference.

### TECHNICAL FIELD

The disclosure relates to a battery cell assembly for a motor vehicle, in particular an electric or hybrid vehicle. The disclosure, furthermore, relates to a motor vehicle, in particular an electric or hybrid vehicle, having such a battery cell assembly.

### BACKGROUND

Battery cells serve for driving an electric motor installed in a motor vehicle. In order to save installation space, the individual battery cells are typically arranged along a so-called stacking direction a short distance away from one another. Since the battery cells develop waste heat during the operation, it is typical to discharge the said waste heat from the battery cells with the help of a coolant, which is thermally brought into contact with the battery cells.

### SUMMARY

It is an object of the present disclosure to provide new ways in the cooling of a battery cell assembly having multiple battery cells.

This object is achieved by battery assembly for a motor vehicle and a motor vehicle as described herein.

Accordingly, it is a general idea to provide so-called cooling structures of a flexible material between battery cells of an assembly of multiple such battery cells to be cooled, which bound a volume through which a coolant can flow and are formed volume-variably in the process. When two adjacent battery cells or their battery cell housings expand because of ageing effects or damage and because of different charge conditions so that the volume of a respective intermediate space between the two adjacent battery cells is reduced, the volume-variable cooling structure of the flexible material can adapt to the reduced volume of the intermediate space. This means that the volume bounded by the cooling structure likewise decreases. When—as proposed in the battery cell assembly introduced here—the cooling structures are now flowed through by the said coolant and the cooling structures are in fluidic connection with a coolant path arranged outside the intermediate spaces, a reduction of the volume of the cooling structure has the consequence that the coolant is pushed, i.e., channeled out of the cooling structures into the coolant path. In this way it is ensured that the maximum possible quantity of coolant is always present in the cooling structure and thus in the intermediate space between two battery cells. This in turn ensures an optimal thermal contact of the coolant with the battery cells. Thus, an optimal discharge of heat from the battery cells is ensured.

In addition, it is possible with the battery cell assembly according to an aspect of the disclosure to determine the expansion of the battery cells or their battery cell housings. This expansion can be detected in different ways. It is conceivable for example to fluidically connect the coolant path with a coolant reservoir. Through a suitable sensor system, the coolant pressure of the coolant in the coolant circuit including the coolant reservoir or the coolant filling level with the coolant of the coolant reservoir can be detected.

However, both the coolant pressure and also the coolant filling level change with the expansion of the battery cells or their battery cell housings: for when the cooling structures, the coolant path and the coolant reservoir are part of a closed type of coolant circuit, a volume reduction of the intermediate spaces between the battery cells and thus also of the cooling structures arranged in the intermediate spaces causes the coolant pressure of the coolant to rise throughout the coolant circuit. This can be measured with a suitable pressure sensor for measuring the coolant pressure. When, by contrast, the cooling structures, the coolant path and the coolant reservoir are part of an open type of coolant circuit, a volume reduction of the intermediate spaces between the battery cells and thus also of the cooling structures arranged in the intermediate spaces causes the coolant to be “pushed” into the coolant reservoir so that the filling level of the same increases. This can be measured with a suitable filling level sensor for determining the filling level of the coolant reservoir with coolant.

Thus, conclusions as to how greatly the battery cells or their battery cell housings have expanded are thus possible via the measurement of the coolant pressure or of the filling level with coolant. At the same time, a highly effective cooling of the battery cells is achieved independently of the actual expansion or volume enlargement of the battery cells since these are thermally in contact with the cooling structures filled with coolant independently of the degree of their expansion. Thus, the waste heat generated by the battery cells during the operation can be transferred to the coolant and from there transported away further, as a result of which the battery cells are effectively cooled. By way of this, a further undesirable expansion of the battery cells is at least counteracted.

A battery cell assembly according to an aspect of the disclosure comprises a stack of multiple battery cells stacked on top of one another along a stacking direction. In intermediate spaces, which are each formed between two battery cells that are adjacent in the stacking direction, a cooling structure of a flexible and heat-conductive material that can be flowed through by a coolant is arranged in each case. Practically, the heat conductivity of this material amounts to at least 0.1 W/(mK). The cooling structure bounds a structure interior in a fluid-tight manner so that the same can be filled with a coolant or be flowed through by the said coolant. For the heat transfer from the battery cells to the coolant present in the cooling structures, the cooling structures concerned each lie—typically flat—against the battery cells. There, the battery cells, the intermediate spaces and the cooling structures are matched to one another in such a manner that upon a volume enlargement of the battery cells the volume of the intermediate spaces and thus also of the cooling structures is correspondingly reduced by the same amount. Through the decrease in volume coolant that is present in the cooling structures is at least partially channeled out or “pushed out” of the respective cooling structure or their structure interior.

According to an exemplary embodiment, the cooling structures are each designed volume-variably. Thus, the cooling structures can lie flat against the battery cells or their battery cell housings, regardless of the extent to which the battery cells or the battery cell housings have expanded. In this way, an optimal thermal contact of the cooling structure and thus of the coolant present in the cooling structure with the battery cells is ensured regardless of the degree of the expansion of the battery cells or their battery cell housings.

Practically, the cooling structure can comprise a covering of the flexible and heat-conductive material, which at least partially bounds the said structure interior in a fluid-tight manner. Thus, the cooling structures can particularly flexibly adapt to a changed volume of the respective battery cell.

Particularly preferably, the cooling structure can, in addition to the covering, comprise a frame, preferentially of a non-elastic material, surrounding the structure interior, to which the covering of the flexible material or the film forming the covering is joined in a substance-bonded manner, in particular welded. In this version, the frame and the covering together bound the structure interior of the cooling structure.

According to an advantageous further development, the individual cooling structures fluidically communicate with one another via at least one coolant path, so that the decrease in volume of the cooling structures causes the coolant that is present in the same is at least partially pushed into the said coolant path. With a suitable sensor system, it is possible to determine the quantity of the coolant channeled out or pushed out of the cooling structures, so that from this the degree to which the battery cells have expanded—in particular caused by ageing or damage or changes in the charging state—can in turn be determined from this.

Particularly preferably, the coolant path fluidically communicates with a coolant reservoir for buffer-storing the coolant channeled out of the cooling structures. This allows an effective buffer storage of the coolant channeled out or pushed out of the cooling structures, so that it is available for the renewed introduction into the cooling structures, should the expansion of the battery cells or their battery cell housings decrease again.

Practically, the coolant reservoir can be designed as a vessel that is fillable with the coolant, preferentially having a predetermined, constant volume. This embodiment version is particularly easily realizable technically speaking.

According to another advantageous further development, the coolant path comprises at least one, typically two, tubular bodies extending along the stacking direction, into which the cooling structures lead. In the cross section, such a tubular body can generally have any geometry—in particular round or angular. The tubular body can be used as inlet or outlet for feeding coolant into the cooling structures or discharging coolant out of the cooling structures—once it has flowed through the same.

Practically, the tubular bodies are produced in a structural form which, compared with the cooling structures, is mechanically stiff. The use of the said tubular bodies makes possible a simple transport of the coolant channeled out or pushed out of the cooling structures, in particular into the coolant reservoir explained above. This is true in particular when the coolant reservoir, as mentioned above, is designed as a vessel that is fillable with the coolant.

Particularly preferably, the intermediate spaces and also the cooling structures are designed or matched to one another in such a manner that the cooling structures, upon an expansion of the volume of the battery cells, are compressed by these.

Particularly preferably, the cooling structures, in particular the coverings, can be preloaded against the battery cells with the pressurized coolant that is present in the cooling structures.

Particularly practically, the cooling structures, in particular the coverings, consist of an elastic material. In this way, the needed volume-variability can be realized in a technically simple manner.

Particularly practically, the material of the cooling structures, in particular of the coverings, is or comprises thermoplastic materials or elastomers. Conceivable in particular is the use of rubber or PVC. However, multi-layered plastic-metal composite films or metal foils are also employable.

According to an advantageous further development, the cooling structures, the at least one coolant path and the coolant reservoir can be arranged in a coolant circuit, in which the coolant can circulate. Thus, the waste heat absorbed by the coolant can be discharged in a simple, effective manner.

According to an advantageous further development, the coolant circuit is designed closed, so that the coolant pressure of the coolant increases when the volume of the battery cells increases and reduced when the volume of the battery cells decreases. Thus it can be determined if and to what extent a volume expansion of the battery cells or the battery cell housing has taken place.

Particularly preferably, a pressure sensor for determining the coolant pressure of the coolant is arranged in this further development in the coolant circuit, preferentially in the coolant reservoir, so that by determining and evaluating the coolant pressure any volume enlargement of the battery cells that may have occurred can be concluded.

According to another advantageous further development, the coolant circuit is designed open or with a volume compensation element such as for example a bellows, so that a filling level of the coolant reservoir with the coolant increases upon an increase of the volume of the battery cells and reduced upon a reduction of the volume of the battery cells.

Particularly preferably, a filling level sensor for determining the filling level of the coolant reservoir with coolant is arranged in the coolant reservoir in this further development. Thus, a volume enlargement of the battery cells that may have occurred can be concluded by determining the filling level of the coolant reservoir with coolant. In particular it can be easily determined if and to what extent a volume expansion of the battery cells or of the battery cell housings has taken place.

The disclosure also relates to a motor vehicle having a battery cell assembly according to the disclosure introduced above. The advantages of the battery cell assembly according to the disclosure explained above therefore apply also to the motor vehicle according to the disclosure. Here, the motor vehicle comprises an air conditioning system which in turn comprises a coolant circuit with which the cooling structures of the battery cell assembly communicate fluidically.

Further important features and advantages of the disclosure are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present disclosure.

### BRIEF DESCRIPTION OF THE DRAWINGS

The disclosure will now be described with reference to the drawings wherein:

FIG. 1 shows a part representation of a battery cell assembly according to an exemplary embodiment of the disclosure,

FIG. 2 shows a section along the section line II-II shown in FIG. 1,

FIG. 3 shows the battery cell assembly shown in FIG. 2 with battery cells which compared with the example of FIG. 2 have an enlarged volume, and

FIG. 4 shows a representation illustrating the integration of the battery cell assembly in an air conditioning system.

### DESCRIPTION OF EXEMPLARY EMBODIMENTS

Exemplary embodiments of the disclosure are shown in the drawings and are explained in more detail in the following description, wherein same reference numbers relate to same or similar or functionally same components.

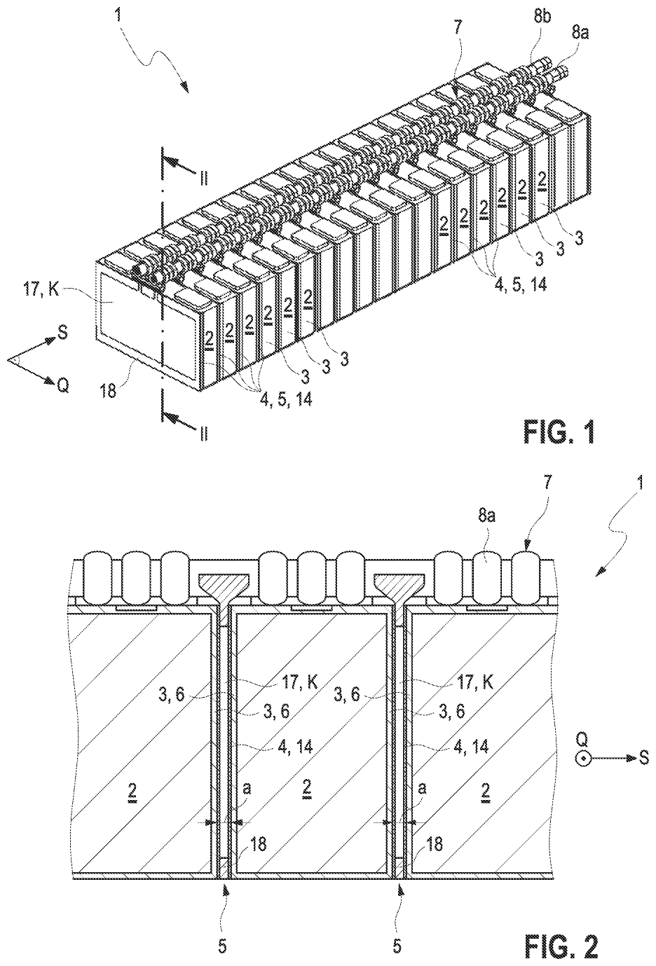

FIG. 1 shows a battery cell assembly 1 according to an exemplary embodiment of the disclosure. The battery cell assembly 1 comprises multiple battery cells 2 stacked on top of one another along a stacking direction S, which in each case comprise a battery cell housing 3. In the exemplary embodiment shown in FIG. 1, such a stack of battery cells 2 is shown. However it is also conceivable that along a transversely direction Q two such stacks 10a, 10b of battery cells 2 are arranged next to one another along a transverse direction Q, which runs perpendicularly to the stacking direction S.

FIG. 2 shows the battery cell assembly 1 of FIG. 1 in a section along the section line II-II shown in FIG. 1. As illustrated in FIG. 2 viewed together with FIG. 1, a cooling structure 4 of a flexible and heat-conductive material that can be flowed through by a coolant K or filled with a coolant K is arranged in each case between two battery cells 2 or battery cell housings 3 that are adjacent in the stacking direction S. Typically, the heat conductivity of this material amounts to at least 0.1 W/(m*K). The cooling structures 4 can each comprise a covering 14 of the flexible and heat-conductive material, which bounds a structure interior 17 at least partially in a fluid-tight manner, so that this structure interior 17 can be filled with the coolant K or flowed through by the same, without the coolant K being able to reach or escape into the external surroundings of the respective cooling structure 4. There it is opportune to select an elastic material as material for the covering 14. Practically, an elastic plastic such as for example polypropylene or other thermoplastic materials or elastomers can be selected as material for the covering 14. However, the use of foils, in particular of multi-layered plastic-metal composite films or metal foils is also conceivable.

In a further development that is evident from the FIGS. 1 and 2, the respective cooling structure 4 can comprise, in addition to the covering 14, a frame 18 surrounding the structure interior 17, typically of a non-elastic plastic, to which the covering 14 of the flexible or elastic material or the foil forming the covering is joined in a substance-bonded manner, in particular welded. In this version, the frame 18 and the covering 14 together bound the structure interior 17 of the cooling structure 4.

For the heat transfer from the battery cells 2 the respective cooling structure 4, the cooling structure 4 or covering 14 concerned lies flat against the battery cells 2 or their battery cell housings 3. Typically, the cooling structures 4 can be pushed by the pressurised coolant K against the battery cells 2 or the battery cell housing walls 6 of the battery cell housing 3 bounding the respective intermediate space 4 or be preloaded against these.

The individual cooling structures 4 communicate fluidically with one another via a coolant path 7. In the exemplary embodiments shown in the figures, this coolant path 7 comprises two tubular bodies 8a and 8b respectively serving as inlet and outlet, into which the cooling structures 4 lead. The individual cooling structures 4 are each formed volume-variably. This means that when pressurized coolant K flows through the cooling structure 4 or the structure interior 17, the material of the cooling structure 4 or of the covering 14 can expand so that the cooling structure 4 or the covering then bounds an enlarged volume.

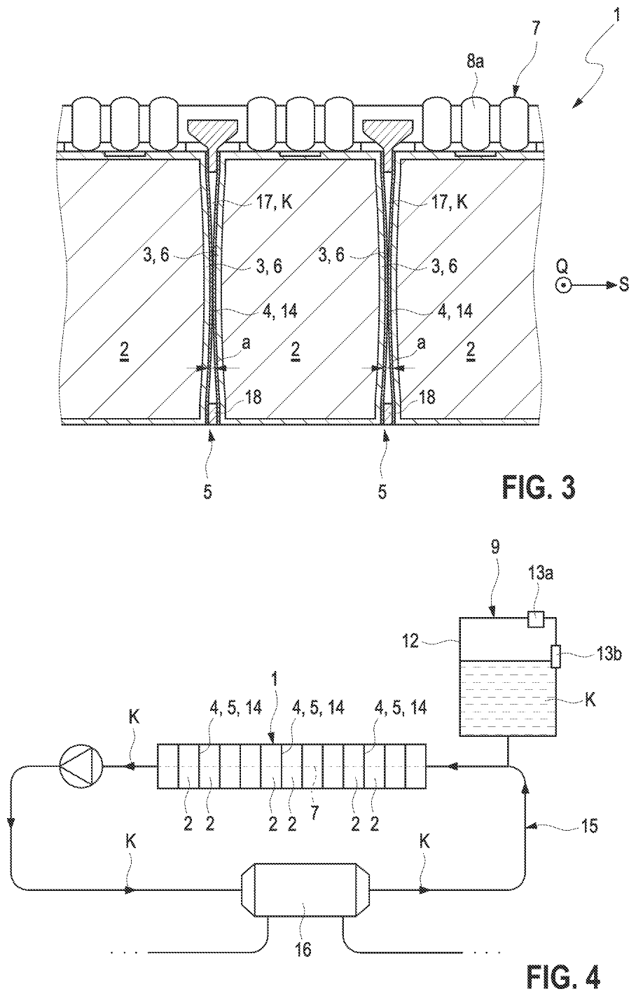

In the following, reference is made to FIG. 3: there, the battery cells 2 or their battery cell housings 3, the intermediate spaces 5 and the cooling structures 4 are designed in such a manner and matched to one another that upon volume enlargement of the battery cells 2 the volume of the intermediate spaces 5 and thus also of the cooling structures 4 is reduced. Such a scenario is illustrated by FIG. 3, in which the volume of the intermediate spaces 5 is reduced relative to the representation of FIG. 2—because of an enlarged volume of the battery cells 2.

As is corroborated by a comparison of FIG. 3 with FIG. 2, a distance a of the battery cell housing walls 6 of those battery cell housings 3, which bound the relevant space 5 along the stacking direction S, is reduced in particular. The intermediate spaces 5 and the associated cooling structures 4 are thus matched to one another in such a manner that the cooling structures 4 upon volume expansion of the battery cells 2 or of the battery cell housings 3 are compressed by these. The volume decrease of the volume of the intermediate space 5 causes the coolant K that is present in the cooling structure 4 or in the structure interior 17 to be “pushed out” of the cooling structure 4 at least partially and thus channeled out into the coolant path 7.

In the following, reference is made to the representation of FIG. 4. As shown in FIG. 4, the cooling structures 4, the coolant path 7 and a coolant reservoir 9 yet to be explained can be arranged in a coolant circuit 15, in which the coolant K can circulate. Such a coolant circuit 15, which for the sake of clarity is only shown in a part extract in FIG. 4, can be integrated in an air conditioning system which is not shown in more detail in FIG. 4, for example for a motor vehicle.

The coolant circuit 15 partially shown in FIG. 4 serves for providing coolant K for cooling the battery cells 2 by heat transfer in the cooling structures 4 and in the cooling path 7, i.e., in the coolant circuit 15. With a heat exchanger 16 arranged in the coolant circuit 15, the heat absorbed by the coolant K can be transferred to another medium and thus discharged out of the coolant circuit 15.

The coolant reservoir 9 mentioned above fluidically communicates in the exemplary scenario with the coolant path 7 and thus, via the same, also with the cooling structures 4. Thus, it can be used for buffer-storing the coolant K channelled out of the cooling structures 4. The coolant reservoir 9 can be practically designed as a vessel 12 with a predetermined constant volume that can be filled with the coolant. In particular, the coolant circuit 15 can be designed closed, so that the coolant pressure of the coolant K upon a volume enlargement of the battery cells 2 increases and upon a volume reduction of the battery cells 2 decreases. In this version, a pressure sensor 13a for determining the coolant pressure of the coolant K can be arranged in the coolant circuit 15, preferentially in the coolant reservoir 9. Thus, by determining the coolant pressure it can be checked if the volume of the battery cells 2 has increased.

In a version alternative thereto, the coolant circuit 15 can be designed open. This means that a filling level of the coolant reservoir 9 with the coolant K increase upon volume enlargement of the battery cells 2 and reduced upon volume reduction of the battery cells 2. Alternatively to an open design, the use of a volume compensation element (not shown) such as for example of a bellows is also conceivable.

In this version, a filling level sensor 13b for determining the filling level of the coolant reservoir 9 with the coolant K can be arranged in the coolant reservoir 9. In this way it can also be determined by determining the filling level of the coolant reservoir 9 with coolant if the volume of the battery cells 2 has increased.

It is understood that the foregoing description is that of the exemplary embodiments of the disclosure and that various changes and modifications may be made thereto without departing from the spirit and scope of the disclosure as defined in the appended claims.

What is claimed is:

1. A battery cell assembly for a motor vehicle, in particular for an electric or hybrid vehicle, the battery cell comprising:
multiple battery cells stacked on top of one another along a stacking direction,
wherein in intermediate spaces between two battery cells that are adjacent in the stacking direction, a cooling structure each of a flexible and heat-conductive material that can be flowed through by a coolant is arranged, which for the heat transfer from the battery cells to the respective cooling structure, typically lies flat against the battery cells, and
wherein the battery cells, the intermediate spaces and the cooling structures are matched to one another in such a manner that upon a volume enlargement of the battery cells the volume of the intermediate spaces and thus also the volume of the cooling structures is reduced, such that through the volume reduction coolant that is present in the cooling structure is at least partially channeled out of the cooling structure.

2. The battery cell assembly according to claim 1, wherein:
the cooling structures are each formed volume-variably, and/or
the cooling structures each comprise a covering of the flexible and heat-conductive material.

3. The battery cell assembly according to claim 1, wherein the individual cooling structures fluidically communicate with one another via at least one coolant path, such that the volume decrease of the cooling structures causes the coolant that is present in these is at least partially channelled out, in particular pushed into the coolant path.

4. The battery cell assembly according to claim 3, wherein the coolant path fluidically communicates with a coolant reservoir for buffer-storing the coolant channeled out of the cooling structures.

5. The battery cell assembly according to claim 4, wherein the coolant reservoir is formed as a vessel that is fillable with the coolant, or with a predefined constant volume.

6. The battery cell assembly according to claim 4, wherein the coolant path comprises at least one, or two tubular bodies extending along the stacking direction, into which the cooling structures lead.

7. The battery cell assembly according to claim 1, wherein:
the intermediate spaces and the cooling structures are matched to one another in such a manner that the cooling structures upon volume expansion of the battery cells are compressed by these, or/and
the cooling structures are preloaded against the battery cells through the pressurized coolant.

8. The battery cell assembly according to claim 1, wherein the cooling structures, in particular the coverings, consist of an elastic material.

9. The battery cell assembly according to claim 1, wherein the material of the cooling structures, in particular of the coverings, comprises thermoplastic materials or/and elastomers or/and multi-layered plastic-metal composite films or/and metal foils.

10. The battery cell assembly according claim 2, wherein the cooling structures, the at least one coolant path, and the coolant reservoir are arranged in a coolant circuit, in which the coolant circulates.

11. The battery cell assembly according to claim 10, wherein the coolant circuit is designed closed, such that the coolant pressure of the coolant in the coolant circuit increases upon a volume enlargement of the battery cells and decreases upon a volume reduction of the battery cells.

12. The battery cell assembly according to claim 10, wherein in the coolant circuit, or in the coolant reservoir, a pressure sensor for determining the coolant pressure is arranged, such that by determining this coolant pressure a volume enlargement of the battery cells that may have taken place can be determined.

13. The battery cell assembly according to claim 10, wherein the coolant circuit is designed open or with a volume compensation element, in particular with a bellows, such that a filling level of the coolant reservoir with the coolant is increased upon volume enlargement of the battery cells and reduced upon volume reduction of the battery cells.

14. The battery cell assembly according to claim 10, wherein in the coolant reservoir a filling level sensor for determining the filling level of the coolant reservoir with coolant is arranged, such that by determining the filling level of the coolant reservoir with coolant a volume enlargement of the battery cells that may have occurred can be determined.

15. A motor vehicle, in particular electric or hybrid vehicle, comprising:
a battery cell assembly according to claim 1; and
an air conditioning system which comprises a coolant circuit, with which the cooling structures of the battery cell assembly communicate fluidically.
